(19) United States
(12) Patent Application Publication
(10) Pub. No.: US 2005/0188057 A1
(43) Pub. Date: Aug. 25, 2005

(54) Contents service system and method using image, and computer readable storage medium stored therein computer executable instructions to implement contents service method

(76) Inventor: Seung-Chul Joo, Kyounggi-do (KR)

Correspondence Address: Thomas M Galgano;Galgano & Burke, Suite 135, 300 Rabro Drive, Hauppauge, NY, 11788, US

(21) Appl. No.: 10/480,520

(22) PCT Filed: Jul. 31, 2002
(86) PCT No.: PCT/KR02/01450

(30) Foreign Application Priority Data
Jul. 31, 2001 (KR) 2001/46380
Jul. 30, 2002 (KR) 2002/44970

(51) Int. Cl. G06F 15/16; G06F 7/00

(52) U.S. Cl. 709/219; 707/10

(57) ABSTRACT

Disclosed is a content service system and a method thereof, and a recording medium having program concerned therewith, wherein contents are output as images or text summaries through a preview window (in another name, preview monitor) before a user makes an access to the lowest rank items included in low rank items of the contents on a designated web page. The content service server includes an image search/output module for outputting contents as images before a user making an access to a web site. More specifically, the image search/ouptut module outputs the lowest rank intems included in the low rank items by simply placing a mouse pointer at one of the low rank items. Thus, the user does not necessarily access to the low rank items included in the high rank items of contents, the high rank items having been registered at a database array in a web page for user's convenience. In addition, when the user places the mouse pointer at one of the lowest rank item theat are output on the screenn, the image search/output module makes a final decision to display the user's wanted image or text summary through a preview window. Accordingly, the user accesses to a final screen by clicking the image displayed through the preview window.

### TECHNICAL FIELD

The present invention relates to a content service system using images and a method thereof, and a recording medium having program concerned therewith. In particular, the present invention relates to a content service system using images and a method thereof, and a recording medium having program concerned therewith, wherein the lowest item out of low rank items of contents in a certain web page is outputted as images.

### BACKGROUND ART

In general, WWW (World-Wide Web) is an information retrieval system for retrieving a vast amount of information that is scattered over the Internet by using hyper media technologies. More specifically, WWW uses a client-server model through which a party who owns information establishes a server to provide the information, and a client can get the information by access to the server through a browser. And, the server makes documents in HTML (Hyper Text Markup Language). Hyper media including a variety of media like text, image, sound is interlinked to one another, thus different servers can be moved more easily along the link.

In addition, there is a universal resource locator (hereinafter referred to as URL), namely naming standard, so that people can retrieve information that is scattered over WWW more conveniently. A client writes a name he or she wants to access in URL format, and accesses to a server including an object information. Normally, URL representation format looks like “protocol://Internet address/directory file name”.

For example, suppose there is a URL that looks like “http://www.modusa.co.kr/tm/tm.cgl?ac=list”. Here, “www.modusaco.kr” indicates a server address where resources are stored, and “/tm/tm.cgl?ac—list” indicates a directory in the server, and using the symbol “/”, people gives a directory name in a file system having hierarchical directories.

A client accesses to an Internet site as follows. First of all, the client drives a web browser. Once the client's web browser is operated, the web browser is physically connected to the Internet through a general Internet connecting means. Here, the web browser is basically interfaced to get an access to a lot of networks and server services. Frequently used web browsers are Explorer, Netscape, or Navigator, all of them being HTML-compatible.

When the web browser is connected to the Internet, a web browser's user specifies a link through the URL, and the client requests a naming service in order to map the URL's host name to a particular network IP (Internet Protocol) address where the server is located. Then, the naming service returns a list of one or more IP addresses in response to the request.

The web browser, using one of the addresses, sets an access to the server, and the connected server outputs a HTML formatted document or another object to the web browser.

On the other hand, a number of Internet users use an Internet search engine many times a day to retrieve thousands of sites without a limit that are scattered over the Internet, and gathers information they want. Two leading search engines currently being used are Yahoo and Alta Vista.

‘Yahoo’ classifies Internet sites and indexes them passively. This is effective for proper classification of web sites in the directory structure, and for generating high quality indexes. Normally, the editorial staff in Yahoo Company visits Internet sites, and register the corresponding site addresses at a directory by classification, and then other users find out the classification directory and access to a wanted site and search sub folders or pages of the site to get the information they have been looking for.

‘Alta Vista’, unlike the classification directory of Yahoo, registers a key word for each site. Therefore, when users input a key word implying the information they want, they are provided with a web site list from which they can gather the information they are looking for, and news group information.

However, those search engines constructed a database only with home page addresses of relevant sites. This means that a user has to go through a main page of each home page (generally, index.html) to get to a specific page or sub-folders within a directory of the site.

In short, a user needs to connect to the home page of a relevant site through a search engine and ultimately to a sub-folder via hierarchical directory of the site, namely dependent connection, to gather information he or she wants or information on product purchase. Therefore, the user had to connect to the first page whatsoever, and then could go to a sub-folder in sequence.

Moreover, when a user tries a classification search on a certain item, too many sites come up randomly, regardless of priority on credit rank of site or quality verification. Thus, general users had to access to that many sites one by one to find out the contents therein, putting so much time and efforts in the course.

For instance, when a customer wants to buy a product, what he or she needs is the information on the kind of products, quality, or price. The thing is that a product is not displayed in one single Internet shopping mall, but it is displayed in several shopping malls, so naturally, the customer would want to compare the numerical reference or specification of the product including the price of the product.

To do so, the user had to click several times to access to the home pages of a number of relevant shopping malls and then get to sub-folders to which the corresponding product belongs, and in such way, the user could check the product information by selecting the corresponding product.

Again, since there are so many Internet shopping malls, it took very long to check the site addresses of those shopping malls and to confirm the information on the corresponding product.

For another thing, users usually manifest their intention to purchase a certain item among many products by placing the item in a shopping bag. However, when they no longer wish to purchase the product, they had to delete the product over and over. In doing so, the users feel very inconvenient and hope for a more convenient product search system.

### DISCLOSURE OF INVENTION

It is, therefore, an object of the present invention to provide a content service system using images and a method thereof, and a recording medium having program concerned therewith, in which the lowest (or least significant) item among low rank items of contents that are included in a designated web page is outputted as an image before connection.

Another object of the present invention is to provide a content service system using images and a method thereof, and a recording medium having program concerned therewith, for which on-line connection, similar to the one general users do, is made over a web and the images of contents are separately databased and registered so that general users can use conveniently.

Still another object of the present invention is to provide a content service system using images and a method thereof, and a recording medium having program concerned therewith, through which users can obtain detailed information of contents by placing a mouse pointer at each item of images that are represented through a preview window (in another name, Preview window) before connecting to a sub-folder, or users can access to a web page containing corresponding contents simply by clicking an item of interest.

Still another object of the present invention is to provide a content service system using images and a method thereof, and a recording medium having program concerned therewith, which provide images as the firstly provided information in connection with contents as users input a content name, thereby enabling the users to recognize that a retrieved content is what they want to get.

Still another object of the present invention is to provide a content service system using images and a method thereof, and a recording medium having program concerned therewith, which provide an interface to enable users to adjust moving status of an output image while it moving to a designated direction.

Still another object of the present invention is to provide a content service system using images and a method thereof, and a recording medium having program concerned therewith, in which users place a mouse pointer at images that represent product information on a web page while it moving at a constant speed, in order to store the images, and see the stored images again later when the image provision is completed.

Yet another object of the present invention is to provide a content service system using images and a method thereof, and a recording medium having program concerned therewith, in which users place a mouse pointer at product images that are provided through a preview window, being provided with users' preference products given that the users input a product name as a key word.

To achieve the above objects, there is provided a content service system using images, which includes a content service server for transferring a web page to a user terminal, where the web page in the content service system is multilevel into a web page with a high rank item of a content, a web page with a plurality of low rank items in correspondence to the web page having the high rank item, and a web page with a plurality of top rank items in correspondence to the web page having the plural low rank items, thereby providing a web page with low rank items to a user whenever the user clicks each rank item, and the content service server includes an image search/output module for outputting the lowest rank items that are included in the lower rank item on a screen, in case that the user clicks a lower rank item included in the high rank item on the web page, the high rank item of a content that is registered at a database server being positioned in a designated array for users' convenience, and when the user clicks a lowest rank item that is outputted on the screen, outputting the lowest rank item as an image.

Preferably, the content service server in the content service system further includes an image registering module for supporting registration of contents, which a user who made on-line connection with the content service server can provide to another user, text information for explaining the contents, and content images to a database server.

The content image that is provided by the image search/output module of the content service server is outputted through the preview window, being shifted to a designated direction.

The image search/output module pops up pre-stored detailed information on the image when a user places a mouse pointer at the moving output image.

The image search/output module outputs a web page including the image onto a screen of the user's terminal when a user double clicks the moving output image.

The content service server further includes a user interface module for enabling the user to control the state of motion of the image that is outputted through the preview window.

The user interface module provides a rewind button for moving the image that is being moved to a designated direction through the preview window to an opposite direction of the original direction, a forward button for moving the image that is being moved to the opposite direction by the rewind button back to the original direction, a fast button for accelerating motion speed of the image, and a slow button for decelerating motion speed of the image.

In case the user inputs a content name and requests a search thereof, the image search/output module of the content service retrieves the content from the database server, and extracts relevant images, and outputs the images while moving the exracted images to a designated direction.

In case the user inputs a content name and price information and requests a searched based thereon, the image search/output module extracts the content from the database server, extracts only a relevant content matching to the price information among the extracted content, loads an image of the relevant content from the database server, and outputs the image while moving the image to a designated direction.

In case the user selects a wanted site and inputs a content to be searched out, the image search/output module extracts contents provided by the site only, loads an image of the extracted contents from the database server, and outputs the image while moving the image to a designated direction.

Preferably, the preview window includes a display window through which a message for explaining a registration procedure of output images through the preview window to the database is outputted. Therefore, when the image is changed in some case, the message on the display window is also changed in response.

Another aspect of the present invention provides a content service system using images, which includes a content service server for transferring a web page to a user terminal, where the web page is multilevel into a web page with a high rank item of a content, a web page with a plurality of low rank items in correspondence to the web page having the high rank item, and a web page with a plurality of top rank items in correspondence to the web page having the plural low rank items, thereby providing a web page with low rank items to a user whenever the user clicks each rank item, and the content service server includes an image search/output module for moving an image of a content selected by the user to a designated direction, outputting the image, providing detailed information thereon when the user clicks the moving output image, and storing the content information when the user inputs a command to store the information while placing a mouse pointer at the image.

The image search/output module, in response to a loading command of the user, loads image information from the content information having been stored during the content search, moves the image information to a designated direction, and outputs the image information.

The content service server further includes a preference check module for generating users' preference information by counting the number of clicking and accumulating the number when the user clicks a product image he or she wants to purchase, and based on the preference information, generating a preference list and providing the preference list through a preview window.

When the user places a mouse pointer at a certain preference information among the preference information in the preference list, the preference check module displays detailed product information on the preview window.

Still another aspect of the present invention provides a content service method using images for transferring a web page to a user terminal, where the web page is multilevel into a web page with a high rank item of a content, a web page with a plurality of low rank items in correspondence to the web page having the high rank item, and a web page with a plurality of top rank items in correspondence to the web page having the plural low rank items, thereby providing the web page with low rank items to a user whenever the user clicks each rank item, the method including the steps of: establishing a database for building a database server by collecting homepage information of contents that are provided over a web, information on high rank items, information on low rank items, information on lowest rank items, and images of the contents, outputting the lowest rank items included in the low rank items on a screen, and outputting the lowest rank item as an image by clicking a lowest rank item among the items outputted on the screen,.

The database building step further includes an image registering step for supporting contents, which is primarily for a user who made an on-line connection with the content service server to be able to provide a designated content to another user, text information for explaining the contents, and images of the contents to be registered at a database.

The content images to be provided to the user are outputted through a preview window, moving to a designated direction at the same time.

When the user places a mouse pointer at the moving output images, pre-stored detailed information on the images is popped up.

When a user double clicks the moving output image, a web page including the image is outputted onto a screen of the user's terminal.

The content providing step further includes a step of providing a user interface for enabling the user to control the state of motion of the image that is outputted through the preview window.

As for providing the user interface, provided is a rewind button for moving the image that is being moved to a designated direction through the preview window to an opposite direction of the original direction, a forward button for moving the image that is being moved to the opposite direction by the rewind button back to the original direction, a fast button for accelerating motion speed of the image, and a slow button for decelerating motion speed of the image.

The content providing step further includes sub-steps of: when the user inputs a content name and requests a search thereof, retrieving the content from the database server, and outputting relevant images, and outputting the extracted images while moving the extracted images to a designated direction.

The content providing step further includes sub-steps of: when the user inputs a content name and price information and requests a search, extracting the content from the database server, extracting only a relevant content matching to the price information among the extracted content, loading an image of the relevant content from the database server, and outputting the image while moving the image to a designated direction.

The content providing step further includes sub-steps of: when the user selects a wanted site and inputs a content to be searched out, extracting contents provided by the site only, loading an image of the extracted contents from the database server, and outputting the image while moving the image to a designated direction.

Still another aspect of the present invention provides a content service method using images in a content service system for transferring a web page to a user terminal, where the web page is multilevel into a web page with a high rank item of a content, a web page with a plurality of low rank items in correspondence to the web page having the high rank item, and a web page with a plurality of top rank items in correspondence to the web page having the plural low rank items, thereby providing the web page with low rank items to a user whenever the user clicks each rank item, the method including the step of: searching/outputting images by moving images of contents selected by the user to a designated direction and outputting the images, and providing detailed information on the image when the user clicks the moving output image, and storing the content information which is relevant to the image when the user inputs a command to store content information while placing a mouse pointer at the image.

The image search/output step includes the sub-steps of: loading image information from the content information having been stored during the content search in response to a loading command of the user, and outputting the image information while moving the image information to a designated direction.

The content service method further includes the step of checking preference, having the step of generating users' preference information by counting the number when the user clicks a product image he or she wants to purchase; generating a preference list based on the preference information, and displaying the preference list through a preview window.

In addition, in the preference check step, when the user places a mouse pointer at certain preference information among the preference information in the preference list, detailed product information is displayed on the preview window.

Yet another aspect of the present invention provides a recording medium on which a content service program is recorded, in which the content service program transfers a web page to a user terminal, where the web page in the content service system is multilevel into a web page with a high rank item of a content, a web page with a plurality of low rank items in correspondence to the web page having the high rank item, and a web page with a plurality of top rank items in correspondence to the web page having the plural low rank items, thereby providing the web page with low rank items to a user whenever the user clicks each rank item, the recording medium including the processes of: establishing a database for building a database server by collecting homepage information of contents that are provided over a web, information on high rank items, information on low rank items, information on lowest rank items, and images of the contents; and outputting the lowest rank items included in the low rank items on a screen by clicking a low rank item included in the high rank item on the web page where high rank items of contents which are registered at the database server are arranged in a designated array for users' convenience, and outputting the lowest rank item as an image by clicking a lowest rank item among the items outputted on the screen.

The database building process further includes sub-step of image registering for supporting registration of contents, part of which being used for a user who made on-line connection with the content service server to provide to another user, text information for explaining the contents, and images of the contents to a database.

The content images to be provided to the user during the content providing process are outputted through a preview window, moving to a designated direction at the same time.

When the user places a mouse pointer at the moving output images, the content providing process pops up pre-stored detailed information on the images on the screen.

When the user double clicks the moving output image, a web page including the image is outputted onto a screen of the user's terminal.

The content providing process further includes a process of providing a user interface for enabling the user to control the state of motion of the image that is outputted through the preview window.

As for providing the user interface, provided is a rewind button for moving the image that is being moved to a designated direction through the preview window to an opposite direction of the original direction, a forward button for moving the image that is being moved to the opposite direction by the rewind button back to the original direction, a fast button for accelerating motion speed of the image, and a slow button for decelerating motion speed of the image.

In the content providing process, when the user inputs a content name and requests a search thereof, the content is retrieved from the database server, and relevant images are outputted, while the output images being moved to a designated direction.

In the content providing process, when the user inputs a content name and price information and requests a search, the content is extracted from the database server, more specifically, only a relevant content matching to the price information among the extracted content is extracted, and then an image of the relevant content is loaded from the database server and then the image is outputted, while the image is being moved to a designated direction.

Further, in the content providing process, when the user selects a wanted site and inputs a content to be searched out, only the contents provided by the site are extracted, and an image of the extracted contents is loaded from the database server and then the image is outputted, while the image is being moved to a designated direction.

Yet another aspect of the present invention provides a recording medium on which a content service program is recorded, in which the recording medium has a content service program mounted on a content service system including a content service server for transferring a web page to a user terminal, where the web page in the content service system is multilevel into a web page with a high rank item of a content, a web page with a plurality of low rank items in correspondence to the web page having the high rank item, and a web page with a plurality of top rank items in correspondence to the web page having the plural low rank items, thereby providing the web page with low rank items to a user whenever the user clicks each rank item, the recording medium including the process of: searching/outputting images by moving images of contents selected by the user to a designated direction and outputting the images, and providing detailed information on the image when the user clicks the moving output image, and storing the content information which is relevant to the image when the user inputs a command to store content information while placing a mouse pointer at the image.

In the image search/output process, responding to a loading command of the user, the image information is loaded from pre-stored content information during the content search, and moved to a designated direction and then outputted.

The image search/output process further includes a preference check process having the process of gernerating users' preference information by counting the number of clicking and accumulating the number when the user clicks a product image he or she wants to purchase, and generating a preference list based on the preference information, and displaying the preference list through a preview window.

In addition, in the preference check process, when the user places a mouse pointer at certain preference information among the preference information in the preference list, detailed product information is displayed on the preview window.

### BRIEF DESCRIPTION OF DRAWINGS

The above objects, features and advantages of the present invention will become more apparent from the following detailed description when taken in conjunction with the accompanying drawings, in which:

FIG. 1 is an explanatory diagram of a content service system using images in accordance with the present invention;

FIGS. 2 through 4 are flow charts explaining a service procedure of the content service system using images in accordance with a preferred embodiment of the present invention;

FIG. 5 is a flow chart explaining a service procedure of the content service system using images in accordance with another preferred embodiment of the present invention;

FIGS. 6 through 8 represent samples of screens that are provided to a user terminal in accordance with the present invention;

FIG. 9 is an explanatory diagram of a content service system using images in accordance with another preferred embodiment of the present invention; and

FIG. 10 is a flow chart explaining a service procedure of the content service system depicted in FIG. 9.

### BEST MODE FOR CARRYING OUT THE INVENTION

A preferred embodiment of the present invention will now be described with reference to the accompanying drawings.

In the content service system according to the preferred embodiment of the present invention, thousands of contents that are provided through web sites, together with images thereof, are included in a database server. And then, the content service system using images performs a content search, the contents are being registered at the database server, and when a user clicks the retrieved information, the system outputs a relevant image thereof, thereby providing the user with more accurate content search.

The preferred embodiment of the present invention includes a computer system with a specific program to which the present invention is applied, and a computer program product to execute the content service method of the invention. According to an embodiment of the present invention, an instruction set for executing the method resides at one or more memories, and the instruction set can be stored as a computer program product in a recording medium like CD-ROM.

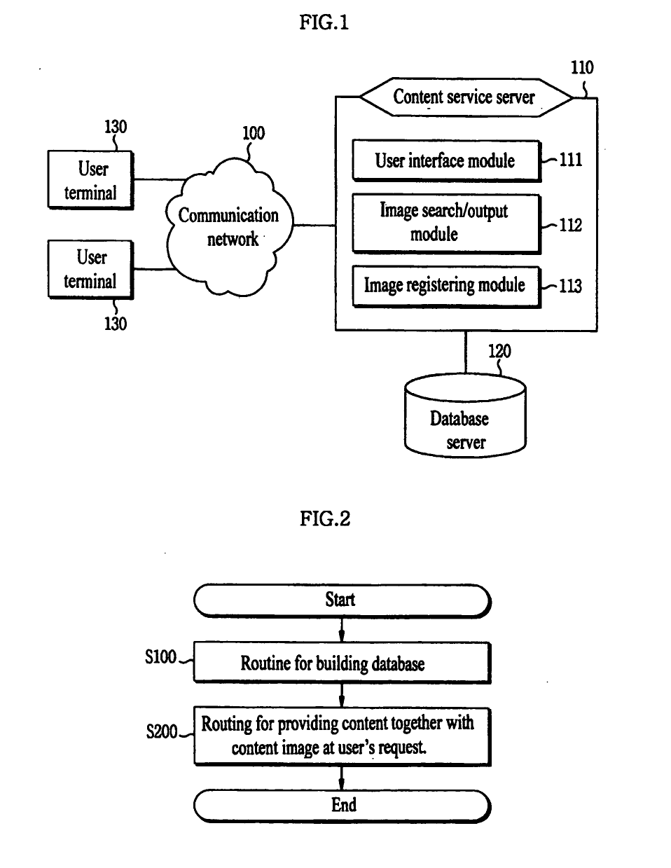

To begin with, FIG. 1 is an explanatory diagram of a content service system using images in accordance with the present invention.

As depicted in the drawing, communication network 100 includes wire and wireless communication networks, and a user of a terminal 130 makes an on-line connection to a content service server 110 (it will be described later). In this manner, the communication network provides a communication environment for the user to search information the content service server 110 provided.

Content service server 110 includes a user interface module 111 for enabling a user to control the state of motion of output images through a preview window, an image search/output module 112 for outputting the lowest rank items that are included in lower rank items on a screen when the user clicks a lower rank item included in high rank items on the web page, in which the high rank items of a content that is registered at a database server are positioned in a designated array for users' convenience, and for outputting the lowest rank item as an image when the user clicks a lowest rank item that is outputted on the screen, and an image registering module 113 for supporting registration of contents, which a user who made an on-line connection to the content service server 110 uses to provide to another user, text information for explaining the contents, and an images of the contents to a database.

The content images provided by the image search/output module 112 in the content service server 110 are outputted through a preview window, and the images are outputted while moving to a designated direction.

The user interface module 111 provides a rewind button for moving the image that is being moved to a designated direction through the preview window to an opposite direction of the original direction, a forward button for moving the image that is being moved to the opposite direction by the rewind button back to the original direction, a fast button for accelerating motion speed of the image, and a slow button for decelerating motion speed of the image.

In case the user places a mouse pointer at the moving output image, the image search/output module 112 pops up pre-stored detailed information on the image on a screen.

In case the user double clicks the moving output image, the image search/output module 112 outputs a web page including the image on a screen of the user's terminal.

In case the user inputs a content name and requests a search thereof, the image search/output module 112 of the content service server retrieves the content from the database server 120, and extracts relevant images therefrom, and outputs the extracted images while moving them to a designated direction.

In case the user inputs a content name and price information for the search item, the image search/output module 112 extracts the content from the database server, and more particularly, it extracts only the content corresponding to the price information among the extracted contents, loads an image of the relevant content from the database server 120, and finally outputs the image while moving it to a designated direction.

When a user places a mouse pointer at the moving output image, the image search/output module 112 pops up pre-stored detailed information on the image.

When a user double selects a wanted site and inputs contents to be searched, the image search/output module 112 extracts only the contents the site provides, and loads an image of the extracted contents from the database server 120, and outputs the image while moving it to a designated direction.

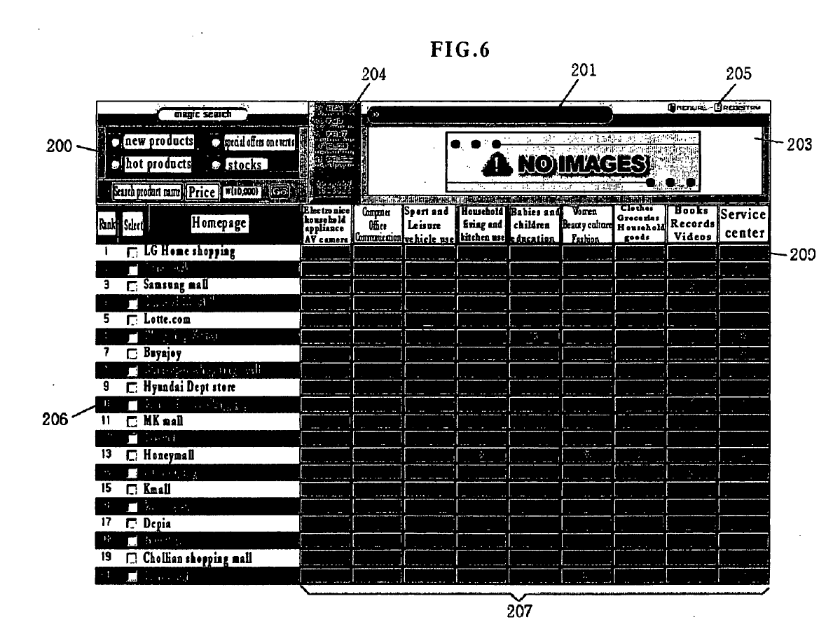

As shown in FIG. 6, the preview window 203 further includes a display window 201 for outputting a message that explains a registration procedure of the output image through the preview window 203 to the database. Therefore, if the image changes, the message in the display window also changes.

FIGS. 6 to 8 represent samples of screens that are provided to a user terminal 130 in accordance with the present invention. More specifically, the screen illustrated in FIG. 6 is the first one that is provided to the user terminal 130 as the user makes an on-line access by using a web browser mounted on the user terminal 130. Here, the reference numeral 200 indicates a search window, where the user selects one of classified items of the content, i.e., new products, special offers on events, hot products, and warehouse goods, inputs a content name in the product name search window that the user wants to be provided with, and inputs price in a price input blank. Then, the image search/output module (112 in FIG. 1), having the classified item, content name and price as keywords, loads a content that could satisfy all of three keywords into an image, and outputs the image to the preview window 203.

The window indicated by the reference numeral 204 includes buttons for controlling the state of motion of output images through the preview window 203, and description on the buttons will not be provided here because it is already provided before in detail. The reference numeral 205 indicates a registration window, which supports the registration of contents, information on the contents, and images of the contents to the database server (120 in FIG. 1).

The reference numeral 206 indicates a homepage list. In case that the user wants to be provided with a content image after inputting a search word, and selects a certain homepage in the homepage list, the user is provided with only the contents the selected homepage provides.

The reference numeral 207 is a classification chart that is prepared by classifying high rank items of the content of home pages in the homepage list, and the reference numeral 209 is a window on which low rank items included in the high rank items are popped up.

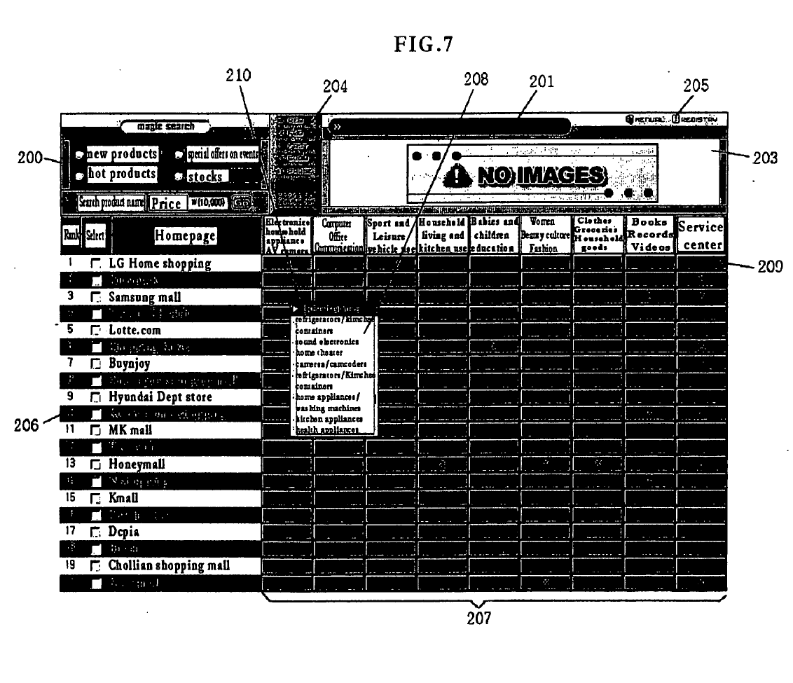

Similar to the reference numeral 209, the popup window 208 depicted in FIG. 7 pops up when the user places a mouse pointer at a window of the intersection of a homepage ‘Samsung mall’ and an electronic home appliances AV camera. For example, the high rank item “Electronics” provides low rank items like “refrigerators/Kimchee containers, sound electronics, home theater, cameras/camcoders, refrigerators/Kimchee containers, home appliances/washing machines, kitchen appliances, and health appliances”.

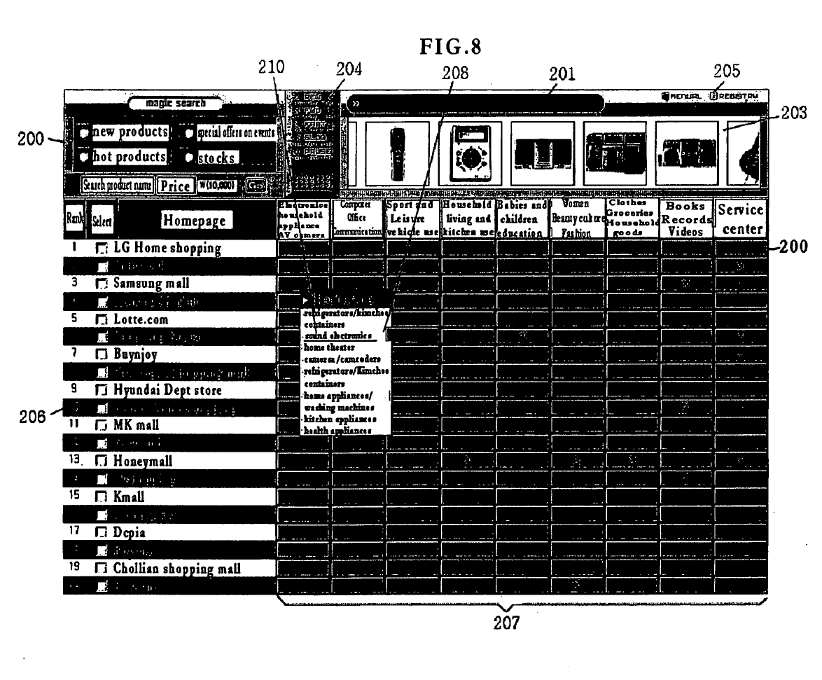

FIG. 8 is illustrated primarily to show what the image search/output module 112 (FIG. 1) does when the user places a mouse pointer at the sound electronics 210 on the popup window 208 of FIG. 7. As manifested in the drawing, the image search/output module loads from the database server 120 (FIG. 1) an image of a content that could satisfy all the categories, “Samsung mall”, “Electronic home appliances AV camera”, and “Sound appliances”, and outputs the image onto the preview window 203.

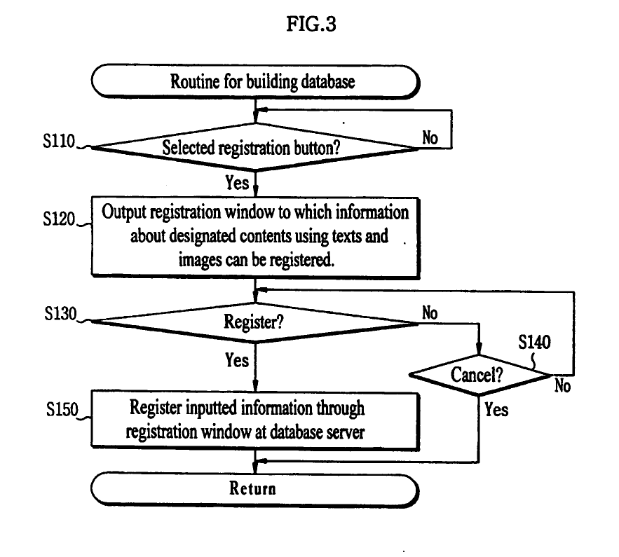

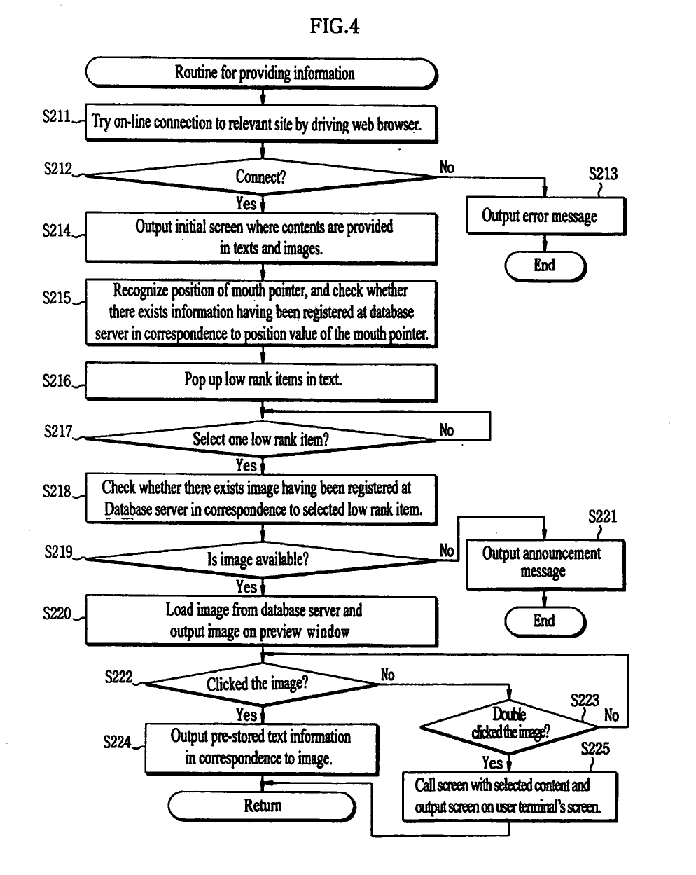

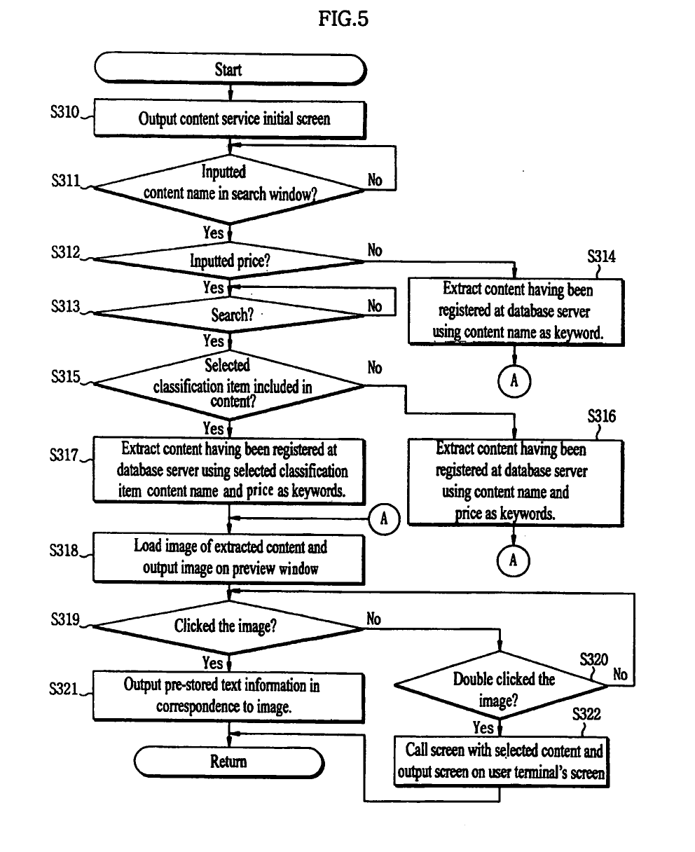

FIGS. 2 to 5 are flow charts explaining a service procedure of the content service system using images in accordance with the present invention.

Referring to FIGS. 2 to 5, the service procedure includes a database building step S100 for building a database server based on homepage information of contents provided on a web, information on high rank items, information on low rank items, information on the lowest items, and contents' images; and a content providing step S200 for outputting the lowest rank items included in the low rank items on a screen when the user clicks a low rank item included in the high rank item on the web page where high rank items of contents which are registered at the database server are arranged in a designated array for users' convenience, and outputting the lowest rank item as an image when the user clicks a lowest rank item among the items outputted on the screen.

The database building step S110 further includes an image registering step S110 to S150 for supporting contents, which is primarily for a user who made an on-line connection with the content service server to be able to provide a designated content to another user, text information for explaining the contents, and images of the contents to be registered at a database.

According to another embodiment of the content providing step S200, when the user places a mouse pointer at a moving output image, pre-stored detailed information on the relevant image pops up, and when a user double clicks the moving output image, the web page including the image is outputted onto the screen of the user's terminal (S211 to S225).

On the other hand, according to another embodiment of the content providing step S200, when the user inputs a content name and requests a search thereof, the content is retrieved from the database server, and relevant images are outputted, by moving the output images to a designated direction; and when the user inputs a content name and price information and requests a searched based thereon, the content is extracted from the database server, more specifically, only a relevant content matching to the price information is extracted among the extracted content, and an image of the relevant content is loaded from the database server, and the image is outputted by moving the image to a designated direction; and when the user selects a wanted site and inputs a content to be searched out, only the contents provided by the site are extracted, an image of the extracted contents is loaded from the database server, and the image is outputted by moving the image to a designated direction (S310 to S322).

Further details on how the user is provided with the retrieved contents in the content service system using the images shown in FIG. 1 in the form of images are now explained with reference to FIGS. 1 to 6 as follows:

Routine for Building Database

As represented in FIG. 2, the user who made an on-line connection to the content service server 110 is provided with the initial screen similar to the one in FIG. 6 onto the user's terminal 130.

The user, using the mouse, clicks a registration request button 205 as show in FIGS. 6 to 8. Then, the image registering module 113 in the content service server 110 makes a decision (S110), and outputs a registration window to which the user can make a registration request by writing the name of a content the user wants to provide to another user and text information for explaining the content, and enclosing an image of the content (S120). When the user clicks a registration button (not shown) after inputting all information he or she is supposed to register at the database server 120 through the registration window, the image registering module 113 registers the inputted data through the registration window by the user at the database server 120 (S150). If the registration button is not clicked by the user within due time, the image registering module 113 finds out whether a cancellation button has been clicked (S140), and if so, it returns to the initial screen.

Contents can be registered at the database server in another way. That is, besides the user, an operator of the content service server 110 can do web surfing on web sites, and capture wanted information, and edit the information before registering it at the database server 120, which is eventually available to the users.

### First Embodiment of Routine for Providing Contents

When a user, by driving a web browser mounted on the user terminal 130, tries an on-line connection to a server 110 that provides a content service using images (S211), the content service server 110 checks the connection (S212), and if the connection is duly made, it transfers the initial screen (refer to FIG. 6) that provides contents in the form of text and image to the user terminal 130 through the communication network 100, thereby outputting the initial screen on the screen of the terminal (S214). If it turns out that the on-line connection is failed at step 212, an error message shows on the screen of the user terminal 130.

On the other hand, the user uses a mouse that is connected to the user terminal 130 to select the content, while changing the position of the mouse pointer on the screen. At this time, the image search/output module 112 of the content service server 110 recognizes the position of the mouse pointer, and in response to the position value of the mouse pointer, checks if there is text information having been registered at the database server 120 (S215).

If it turns out that there exists the text information (S216) in the database server 120 at step 215, the image search/output module 112 reads the text information, and provides low rank items of the content through the popup window 208 as show in FIG. 7 or 8 (S216).

And, the image search/output module 112 finds out when the user selected a certain low rank item among the low rank items that are provided through the popup window 208 as show in FIG. 7 or 8) (S217). When the user selected a low rank item at step 217, the image search/output module 112, in response to the selected low rank item, checks if there is a registered image concerned therewith in the database server 120 (S218).

Based on checking at step 218, the image search/output module 112 concludes whether the database server 120 has the image (S219). If it turns out that there is the image, the image search/output module 112 loads the image from the database server 120, and outputs it through the preview window 203 as shown in FIGS. 6 to 8 (S220). However, if there is no image registered at the database server 120, the image search/output module 112 outputs an announcement message looks like “There is no image registered” through the preview window 203 (S221).

Here, the image on the preview window 203 is outputted while shifting from the right side to the left side, and the preview window 203 includes a window 204 at the corner having image operation control buttons, such as, a rewind button, a forward button, a slow button, and a fast button.

The image search/output module 112 decides whether the user clicks the image being loaded on the preview window 203 once (S222). If it turns out the user clicked the image once, the image search/output module 112 pops up pre-stored text information in connection with the image (S224), and returns to the main page.

In the meantime, the image search/output module 112 finds out whether the user double clicked the output image through the preview window 203 or not (S223), and if so, it calls the screen including the selected content and outputs the screen onto the screen of the user terminal 130 (S225).

### Second Embodiment of Routine for Providing Contents

FIG. 5 is a flow chart explaining a service procedure of the content service system embodying the principles of the present invention.

As depicted in the drawing, when a user, by driving a web browser mounted on the user terminal 130, makes an on-line connection to a server 110 that provides a content service using images, the initial screen (refer to FIG. 6), through which the user can be provided with the content in the format of text and image having been transferred through the communication network 100, is outputted on the screen of the user terminal 130 (S310).

Then, the image search/output module 112 decides whether the user inputted a content name in the content name input blank on the search window 200 of the initial screen (S311). When the user inputted the content name, the image search/output module 112 finds out when the user inputted the price of the content in the price input blank on the search window 200 (S312).

If it turns out that the content name and the content price are duly inputted at step 312, the image search/output module 112 decides whether the search button (e.g., ‘go’ button included in the search window 200 of FIG. 6) has been clicked by the user (S313). On the other hand, if it turns out that only the content name is inputted at step 312, the image search/output module 112 extracts content that has been registered at the database server 120 by using the content name as keyword (S314). After that, the image search/output module 112 loads the image of the extracted content from the database server 120, and outputs the image through the preview window 203 (S318).

At the result of the decision made at step 323, when the user clicked the search button (‘go’ button), the image search/output module 112 which item the user selected among new products, special offers on events, hot products, and warehouse goods (S315).

When the user did not select any classification item at step 315, the image search/output module 112, using the content name and the content price as keywords, extracts a content that has been registered at the database server 120 (S316). Then, the image search/output module 112 loads the image of the extracted content from the database server 120, and outputs the image through the preview window 203 (S318).

However, if it turns out that the user selected one item (i.e., one of new products, special offers on events, hot products, and warehouse goods) at step 315, the image search/output module 112, using the selected classification item, the content name and the content price as keywords, extracts a content that has been registered at the database server 120 (S317). Then, the image search/output module 112 loads the image of the extracted content from the database server 120, and outputs the image through the preview window 203 (S318).

In the meantime, the image search/output module 112 finds out when the user clicked the image being loaded onto the preview window 203 once (S319). If it turns out the user clicked the image once, the image search/output module 112 outputs pre-stored text information in connection with the image through the popup window 208 as shown in FIG. 7 or 8) (S321), and returns to the main page.

On the other hand, the image search/output module 112 finds out whether the user double clicked the output image through the preview window 203 or not (S320), and if so, it calls the screen including the selected content and outputs the screen onto the screen of the user terminal 130 (S322).

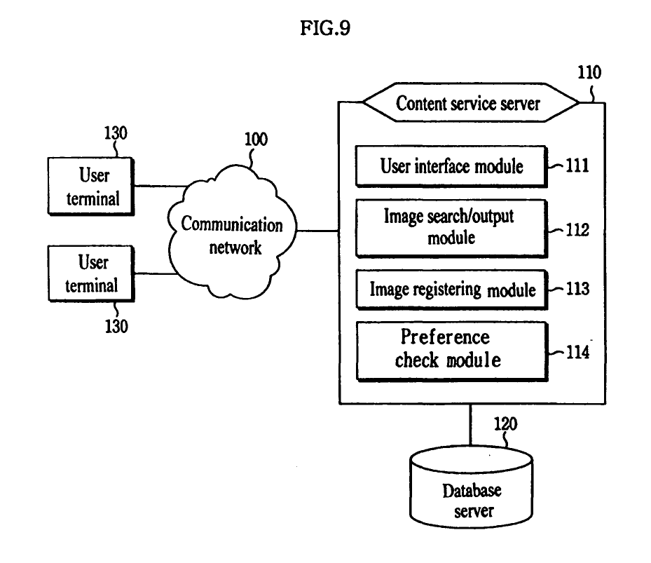

FIG. 9 is an explanatory diagram of a content service system using images in accordance with another preferred embodiment of the present invention.

The user interface module 111 depicted in FIG. 9 has the user place a mouse pointer at an image moving to a designated direction through the preview window by using a rewind button, forward button, slow button, or fast button, to select the image and store the image later.

In addition, the user interface module 111 further provides a store button for the user, so when the user reselects the image after the image search is completed, the pre-stored image is outputted again through the preview window.

Preference check module 114, on the other hand, generates user preference information by counting the number of clicks the user does on the product image he or she wants to purchase. Further, based on this preference information, a preference list is generated, and provided to the user through the preview window.

When the user places the mouse pointer at certain preference information among the preference information in the preference list, the preference check module 114 displays the detailed information on the product on the preview window.

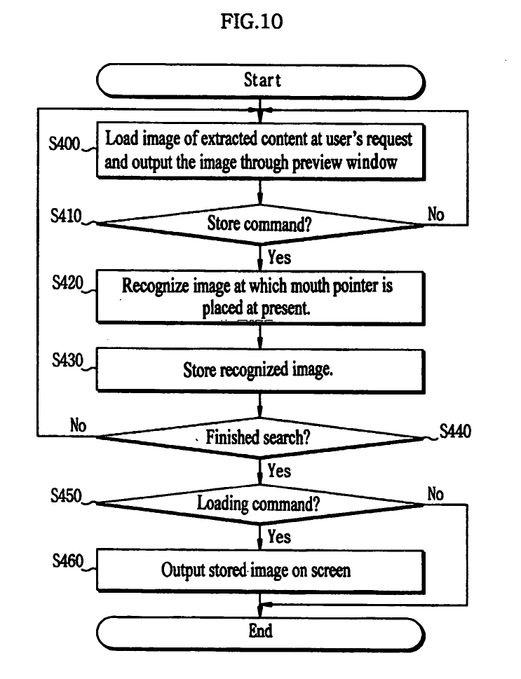

FIG. 10 is a flow chart explaining a service procedure of the content service system depicted in FIG. 9.

As illustrated in FIG. 10, the image search/output module 112 extracts content from the database server 120 to meet the request of the user, and loads the image of the extracted content, and outputs the image through the preview window (S400). At this time, the content image is displayed while moving from the right side to the left side on the preview window.

In such state where the user has an option to search the content, the image search/output module 112 checks when the user inputted a key signal.

And, the image search/output module 112 finds out if the key signal is a ‘store’ command (S410). If it turns out that it is the store command (i.e., ‘Yes’ at step 410), the image search/output module 112 recognizes the image at which the mouse pointer is located at present (S420), and stores the image recognized in an internal storing means (S430). However, if it turns out that the key signal is not the store command at step 410 (i.e., ‘No’ at step 410), the image search/output module 112 repeats the procedure starting form step 400.

Meanwhile, if a loading command is inputted at step 450 (i.e., ‘Yes’ at step 4500, the image search/output module 112 outputs an image having been stored onto the screen (S460), and ends the procedure. However, if the loading command has not been inputted at step 450 (i.e., ‘No’ at step 450), the image search/output module 112 ends the searching process.

Lastly, the following explains the preference check procedure. As mentioned before, the preference check module 114 of the content service server to which the present invention is applied generates user preference information by counting the number of clicks the user does on the product image he or she wants to purchase. Further, based on this preference information, the preference check module 114 generates a preference list, and provides the list to the user through the preview window.

When the user places the mouse pointer at certain preference information among the preference information in the preference list, the preference check module 114 displays the detailed information on the product on the preview window.

### Industrial Applicability

The present invention helps users to select products they want (or contents) more accurately, by outputting the images of the lowest rank items out of low rank items of the contents included in a certain web page.

The present invention enables users to register content images through the ordinary on-line connection with other general users, thereby providing more content images to general users. Therefore, users can register their wanted products (contents) even in a place without any server.

The present invention saves users' time by helping them to access directly to a web page having a relevant content they wanted to get, simply by doubling clicking, or providing detailed information of the content as users click a certain image. In this manner, users do not need to go through the clicking process several times to get the information they need.

The present invention provides users with all kinds of services they want at once by searching the products (contents) they are interested in, based on at least one of homepage, classification item (new products, special offers on events, hot products, and warehouse goods), content name, and price the users inputted.

The present invention helps users to observe a content image better by providing an interface means through which the users can adjust the state of motion of the output image, while the image is being moved to a certain direction.

The present invention helps users to compare prices and designs of the products they chose one more time by providing a system through which the users place a mouse pointer at a moving image on a web page, the image representing product information, and store the image for later use.

Lastly, the present invention improves users' abilities to have better shopping by providing the user preference priority on similar products. The only thing the users need to do is to place a mouse pointer at a product image that is being provided through a preview window, and using the product name as keyword, the present invention provides the users with the user preference priority on similar products.

While the invention has been shown and described with reference to certain preferred embodiments thereof, it will be understood by those skilled in the art that various changes in form and details may be made therein without departing from the spirit and scope of the invention as defined by the appended claims.

1. A content service system using images, which includes a content service server for transferring a web page to a user terminal, where the web page in the content service system is multilevel into a web page with a high rank item of a content, a web page with a plurality of low rank items in correspondence to the web page having the high rank item, and a web page with a plurality of top rank items in correspondence to the web page having the plural low rank items, thereby providing a web page with low rank items to a user whenever the user clicks each rank item, the content service server comprising:
an image search/output module for outputting the lowest rank items that are included in the lower rank item on a screen when the user clicks a lower rank item included in the high rank item on the web page, in which the high rank item of a content having been registered at a database server is arranged in a designated array for users' convenience, and for outputting the lowest rank item as an image when the user clicks a lowest rank item that is outputted on the screen.

2. The system according to claim 1, wherein the content service server further comprises an image registering module for supporting registration of contents, part of which being used by a user who made on-line connection with the content service server to provide to another user, text information for explaining the contents, and an image of the contents to a database.

3. The system according claim 1 or 2, wherein the content image provided by the image search/output module is outputted through a preview window while being moved to a designated direction.

4. The system according to claim 3, wherein the image search/output module pops up pre-stored detailed information relevant to the image onto a screen when a user places a mouse pointer at the moving output image.

5. The system according to claim 3, wherein the image search/output module outputs a web page including the image onto a screen of the user's terminal when a user double clicks the moving output image.

6. The system according to claim 3, wherein the content service server further comprises a user interface module for enabling the user to control the state of motion of the image that is outputted through the preview window.

7. The system according to claim 5, wherein the user interface module provides a rewind button for moving the image that is being moved to a designated direction through the preview window to an opposite direction of an original direction, a forward button for moving the image having been moved to the opposite direction by the rewind button back to the original direction, a fast button for accelerating motion speed of the image, and a slow button for decelerating motion speed of the image.

8. The system according to claim 1 or 2, wherein the image search/output module retrieves the content from the database server, extracts relevant images, and outputs the extracted images while moving the output images to a designated direction when the user inputs a content name and requests a search thereof.

9. The system according to claim 1 or 2, wherein, the image search/output module extracts the content from the database server, extracts only a relevant content matching to the price information among the extracted content, loads an image of the relevant content from the database server, and outputs the image while moving the image to a designated direction when the user inputs a content name and price information and requests a search.

10. The system according to claim 8, wherein the image search/output module extracts contents provided by the site only, loads an image of the extracted contents from the database server, and outputs the image while moving the image to a designated direction when the user selects a wanted site and inputs a content to be searched out.

11. The system according to claim 3, wherein the preview window further comprises a display window for outputting a message that explains a registration procedure of output images through the preview window to the database, so as to change the message on the display window in case the image is changed.

12. A content service system using images, which includes a content service server for transferring a web page to a user terminal, where the web page is multilevel into a web page with a high rank item of a content, a web page with a plurality of low rank items in correspondence to the web page having the high rank item, and a web page with a plurality of top rank items in correspondence to the web page having the plural low rank items, thereby providing a web page with low rank items to a user whenever the user clicks each rank item, the content service server comprises:
an image search/output module for moving an image of a content selected by the user to a designated direction, outputting the image, providing detailed information thereon when the user clicks the moving, output image, and storing the content information when the user inputs a command to store the information while placing a mouse pointer at the image.

13. The system according to claim 12, wherein the image search/output module, in response to a loading command of the user, loads image information from the content information having been stored during the content search, moves the image information to a designated direction, and outputs the image information.

14. The system according to claim 12, wherein the content service server further comprises a preference check module for generating users' preference information by counting number of clicking and accumulating the number whenever the user clicks a product image the user wants to purchase, and generating a preference list based on the preference information, and providing the preference list through a preview window.

15. The system according to claim 14, wherein, the preference check module displays detailed product information on the preview window when the user places a mouse pointer at a certain preference information among the preference information in the preference list.

16. A content service method using images for transferring a web page to a user terminal, where the web page is multilevel into a web page with a high rank item of a content, a web page with a plurality of low rank items in correspondence to the web page having the high rank item, and a web page with a plurality of top rank items in correspondence to the web page having the plural low rank items, thereby providing the web page with low rank items to a user whenever the user clicks each rank item, the method comprising the steps of:
establishing a database for building a database server by collecting homepage information of contents that are provided over a web, information on high rank items, information on low rank items, information on lowest rank items, and images of the contents; and
outputting the lowest rank items included in the low rank items on a screen by clicking a low rank item included in the high rank item on the web page where high rank items of contents which are registered at the database server are arranged in a designated array for users' convenience, and outputting the lowest rank item as an image by clicking a lowest rank item among the items outputted on the screen.

17. The method according to claim 16, wherein the step of establishing a database further comprising the step of:
registering an image for supporting registration of contents, part of which being used by a user who made an on-line connection with the content service server to provide to another user, text information for explaining the contents, and an image of the contents to a database.

18. The method according to claim 16 or claim 17, wherein the content images to be provided to the user by the content providing step are outputted through a preview window, while moving to a designated direction at the same time.

19. The method according to claim 18, wherein the content providing step pops up pre-stored detailed information relevant to the images on the screen when the user places a mouse pointer at the moving output images

20. The method according to claim 18, wherein the content providing step outputs a web page including the image onto a screen of the user's terminal when a user double clicks the moving output image.

21. The method according to claim 18, wherein the content providing step further comprising the step of:
providing a user interface for enabling the user to control the state of motion of the image that is outputted through the preview window.

22. The method according to claim 21, wherein the user interface is comprised of a rewind button for moving the image that is being moved to a designated direction through the preview window to an opposite direction of an original direction, a forward button for moving the image that is being moved to the opposite direction by the rewind button back to the original direction, a fast button for accelerating motion speed of the image, and a slow button for decelerating motion speed of the image.

23. The method according to claim 16 or claim 17, wherein the content providing step further comprises sub-steps of:
when the user inputs a content name and requests a search thereof, retrieving the content from the database server, and extracting relevant images; and
outputting the extracted images while moving the extracte images to a designated direction.

24. The method according to claim 16 or claim 17, wherein the content providing step further comprising sub-steps of:
extracting the content from the database server when the user inputs a content name and price information and requests a searched based thereon; and
extracting only a relevant content matching to the price information among the extracted content, and loading an image of the relevant content from the database server, thereby outputting the image while moving the image to a designated direction.

25. The method according to claim 23, wherein the content providing step further comprises sub-steps of:
extracting contents provided by the site only when the user selects a wanted site and inputs a content to be searched out; and
loading an image of the extracted contents from the database server, thereby outputting the image while moving the image to a designated direction.

26. A content service method using images in a content service system for transferring a web page to a user terminal, where the web page is multilevel into a web page with a high rank item of a content, a web page with a plurality of low rank items in correspondence to the web page having the high rank item, and a web page with a plurality of top rank items in correspondence to the web page having the plural low rank items, thereby providing the web page with low rank items to a user whenever the user clicks each rank item, the method comprising the step of:
searching/outputting images by moving images of contents selected by the user to a designated direction and outputting the images, and providing detailed information on the image when the user clicks the moving output image, and storing the content information which is relevant to the image when the user inputs a command to store content information while placing a mouse pointer at the image.

27. The method according to claim 26, wherein the step of searching/outputting images comprising the step of loading image information from the content information having been stored during the content search, in response to a loading command of the user, and outputting the image information while moving the image information to a designated direction.

28. The method according to claim 26, further comprising the step of checking preference, having the step of generating users' preference information by counting the number of clicking and accumulating the number when the user clicks a product image he or she wants to purchase; generating a preference list based on the preference information; and displaying the preference list through a preview window.

29. The method according to claim 28, wherein when the user places a mouse pointer at certain preference information among the preference information in the preference list, the detailed product information is displayed on the preview window.

30. A recording medium on which a content service program using images is recorded, in which the content service program transfers a web page to a user terminal, where the web page in the content service system is multilevel into a web page with a high rank item of a content, a web page with a plurality of low rank items in correspondence to the web page having the high rank item, and a web page with a plurality of top rank items in correspondence to the web page having the plural low rank items, thereby providing the web page with low rank items to a user whenever the user clicks each rank item, the recording medium including the processes of:
establishing a database for building a database server by collecting homepage information of contents that are provided over a web, information on high rank items, information on low rank items, information on lowest rank items, and images of the contents; and
outputting the lowest rank items included in the low rank items on a screen by clicking a low rank item included in the high rank item on the web page where high rank items of contents which are registered at the database server are arranged in a designated array for users' convenience, and outputting the lowest rank item as an image by clicking a lowest rank item among the items outputted on the screen.

31. The recording medium according to claim 30, wherein the content providing process further comprises sub-step of: image registering process for supporting registration of contents, part of which being used for a user who made on-line connection with the content service server to provide to another user, text information for explaining the contents, and images of the contents to a database.

32. The recording medium according to claim 30 or claim 31, wherein the content images to be provided to the user during the content providing process are outputted through a preview window, moving to a designated direction at the same time.

33. The recording medium according to claim 32, wherein the content providing process pops up pre-stored detailed information relevant to the images on the screen when the user places a mouse pointer at the moving output images.

34. The recording medium according to claim 32, wherein the content providing process outputs a web page including the image onto a screen of the user's terminal when a user double clicks the moving output image.

35. The recording medium according to claim 32, wherein the content providing process further comprising the process of:
providing a user interface for enabling the user to control the state of motion of the image that is outputted through the preview window.

36. The recording medium according to claim 34, wherein the user interface is comprised of a rewind button for moving the image that is being moved to a designated direction through the preview window to an opposite direction of the original direction, a forward button for moving the image that is being moved to the opposite direction by the rewind button back to the original direction, a fast button for accelerating motion speed of the image, and a slow button for decelerating motion speed of the image.

37. The recording medium according to claim 30 or 31, wherein the content providing process comprises sub-steps of:
when the user inputs a content name and requests a search thereof, retrieving the content from the database server, and extracting the relevant image; and
outputting the extracted images while moving the extracted images to a designated direction.

38. The recording medium according to claim 30 or 31, wherein the content providing process comprises sub-steps of:
when the user inputs a content name and price information and requests a search, extracting the content from the database server; and
extracting only a relevant content matching to the price information among the extracted content, and loading an image of the relevant content from the database server, thereby outputting the image while moving the image to a designated direction.

39. The recording medium according to claim 37, wherein when the user selects a wanted site and inputs a content to be searched out, only the contents provided by the site are extracted, and an image of the extracted contents is loaded from the database server and then the image is outputted while being moved to a designated direction.

40. A recording medium on which a content service program is recorded, in which the recording medium has a content service program mounted on a content service system including a content service server for transferring a web page to a user terminal, where the web page in the content service system is multilevel into a web page with a high rank item of a content, a web page with a plurality of low rank items in correspondence to the web page having the high rank item, and a web page with a plurality of top rank items in correspondence to the web page having the plural top low rank items, thereby providing the web page with low rank items to a user whenever the user clicks each rank item, the recording medium comprising the steps of:
searching/outputting images by moving images of contents selected by the user to a designated direction and outputting the images, and providing detailed information on the image when the user clicks the moving output image, and storing the content information which is relevant to the image when the user inputs a command to store content information while placing a mouse pointer at the image.

41. The recording medium according to claim 40, wherein the image search/output process involves loading image information from pre-stored content information during the content search in response to a loading command of the user, and outputting the image information while moving the image information to a designated direction.

42. The recording medium according to claim 40, further comprising the process of checking preference having the process of generating users' preference information by counting the number of clicking and accumulating the number when the user clicks a product image he or she wants to purchase, generating a preference list based on the preference information, and displaying the preference list through a preview window.

43. The recording medium according to claim 42, wherein, when the user places a mouse pointer at certain preference information among the preference information in the preference list, the detailed product information is displayed on the preview window.
